(19) United States
(12) Patent Application Publication
(10) Pub. No.: US 2008/0204449 A1
(43) Pub. Date: Aug. 28, 2008

(54) ENABLEMENT OF VIRTUAL ENVIRONMENT FUNCTIONS AND FEATURES THROUGH ADVERTISEMENT EXPOSURE

(76) Inventors: Christopher J. Dawson, Arlington, VA (US); Rick A. Hamilton, Charlottesville, VA (US); Clifford A. Pickover, Yorktown Heights, NY (US); James W. Seaman, Falls Church, VA (US)

Correspondence Address: HOFFMAN WARNICK LLC, 75 STATE ST, 14TH FLOOR, ALBANY, NY, 12207, US

(21) Appl. No.: 11/679,432

(22) Filed: Feb. 27, 2007

(51) Int. Cl. G06T 15/00

(52) U.S. Cl. 345/419

(57) ABSTRACT

The present invention relates to the enablement of virtual universe functions and features through advertisement exposure. A method in accordance with an embodiment of the present invention includes: viewing, by the avatar, advertising content within the virtual environment; and earning a number of points for viewing the advertising content.

### FIELD OF THE INVENTION

The present invention relates to advertising, and more specifically relates to the enablement of virtual environment functions and features through advertisement exposure.

### BACKGROUND OF THE INVENTION

A virtual environment is an interactive simulated environment accessed by multiple users through an online interface. Users inhabit and interact in the virtual environment via avatars. This habitation usually is represented in the form of avatars, which are two or three-dimensional graphical representations of humanoids. There are many different types of virtual environments, however there are several features most virtual environments have in common:

A) Shared Space: the world allows many users to participate at once.
B) Graphical User Interface: the environment depicts space visually, ranging in style from 2D “cartoon” imagery to more immersive 3D environments.
C) Immediacy: interaction takes place in real time.
D) Interactivity: the environment allows users to alter, develop, build, or submit customized content.
E) Persistence: the environment's existence continues regardless of whether individual users are logged in.
F) Socialization/Community: the environment allows and encourages the formation of social groups such as teams, guilds, clubs, cliques, housemates, neighborhoods, etc.

An avatar can have a wide range of business and social experiences. Such business and social experiences are becoming more common and increasingly important in on-line virtual environments (e.g., universes, worlds, etc.), such as that provided in the on-line world Second Life (Second Life is a trademark of Linden Research in the United States, other countries, or both). The Second Life client program provides its users (referred to as residents) with tools to view, navigate, and modify the Second Life world and participate in it's virtual economy.

Second Life and other on-line virtual environments present a tremendous new outlet for both structured and unstructured virtual collaboration, gaming and exploration, as well as real-life simulations in virtual spaces. These activities, along with yet to be disclosed new dimensions, in turn provide a wide open arena for creative and new advertising methods and mechanisms. Unfortunately, existing advertising methods and mechanisms generally have a high nuisance factor and are widely disliked by users.

### SUMMARY OF THE INVENTION

The present invention relates to the enablement of virtual environment functions and features through advertisement exposure. Incentives are provided to avatars to view advertisements to gain access to features and functions available in the virtual environment, and/or to enhance existing features and functions available in the virtual environment. Hereafter, the term “enable” is used to collectively refer to the gaining of access to features and functions in the virtual environment, and/or the enhancement of existing features and functions in the virtual environment. Avatars viewing more advertisements compile more points, and thus have access to more virtual environment functions and features. In accordance with the present invention, the phrase “virtual environment” comprises any and all virtual spaces or locations, such as universes, worlds, countries, cities, buildings, etc., in which a user's avatar exists and interacts.

A first aspect of the present invention is directed to a method for enabling aspects of a virtual environment to an avatar, comprising: viewing advertising content within the virtual environment; and earning a number of points for viewing the advertising content.

A second aspect of the present invention is directed to a system for enabling aspects of a virtual environment to an avatar, comprising: a system for viewing advertising content within the virtual environment; and a system for earning a number of points for viewing the advertising content.

A third aspect of the present invention is directed to a program product stored on a computer readable medium, which when executed, enables aspects of a virtual environment to an avatar, the computer readable medium comprising program code for: viewing advertising content within the virtual environment; and earning a number of points for viewing the advertising content.

A fourth aspect of the present invention is directed to a method for deploying an application for enabling aspects of a virtual environment to an avatar, comprising: providing a computer infrastructure being operable to: view advertising content within the virtual environment; and earn a number of points for viewing the advertising content.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 is an illustrative hybrid system/process diagram depicting the accumulation of advertisement based points in a virtual environment in accordance with an embodiment of the present invention.

FIG. 2 is an illustrative hybrid system/process diagram depicting the spending of advertisement based points in a virtual environment in accordance with an embodiment of the present invention.

FIG. 3 is an illustrative hybrid system/process diagram depicting the accessing of restricted virtual spaces in a virtual environment in accordance with an embodiment of the present invention.

FIG. 4 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention relates to the enablement of virtual universe functions and features through advertisement exposure.

Virtual environments provide a new and potentially mutually beneficial advertising medium for both the consumer and companies sponsoring advertisements. The present invention discloses a mutually beneficial advertising method in which avatars are given incentives, such as enhanced capabilities and the like, to view advertisements within a virtual environment.

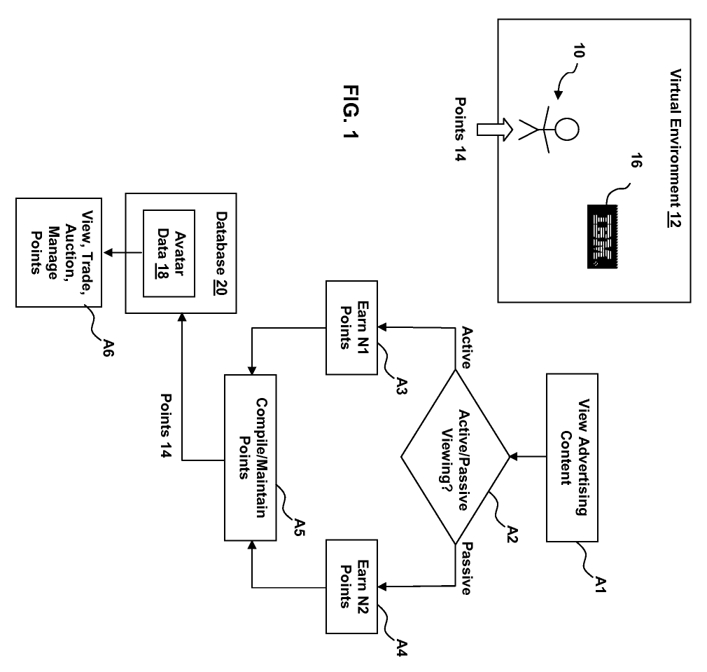

A virtual environment often provides its “residents” with various methods and means to traverse and manipulate their environments. In general, these capabilities are the same from one avatar to another. As an example, in Second Life, an avatar has the capability to walk, fly, float, teleport, trade, access inventory, etc. In accordance with the present invention, an avatar is provided with staged levels of capabilities based on its support of sponsoring advertisers. For example, in an embodiment, as depicted in FIG. 1, an avatar 10 in a virtual environment 12 earns one or more points 14 based on viewing (A1) advertising content 16. Such viewing can be active or user-prompted (e.g., by clicking on or otherwise actuating an advertisement), or may be passive (e.g., by entering a location where a sponsor's logo or advertisement is located).

In an embodiment, active viewing (Active, A2) of advertising content 16 generates (A3) a first number N1 of points 14 for the avatar 10, while passive viewing (Passive, A2) of advertising generates (A4) a second number of points 14 for the avatar 10. The points 14 can be compiled and maintained (A5), for example, as part of the avatar's data 18 (e.g., inventory, profile, etc.) in a database 20. The first number N1 of points 14 can be larger than the second number N2 of points 14 due to the active nature of the viewing. Alternatively, the first number N1 of points 14 can be the same as or less than the second number N2 of points 14. Other point allocation methodologies are also possible, and the above-described examples are not intended to be limiting in any way. In other embodiments, rather than points, an avatar can be provided with tokens, money, or other types of rewards for viewing advertising content.

Points 14 are intended to encompass any type of remuneration now used, or later developed for use in, a virtual environment, on-line game, etc. This can include, for example, numerical points, gold, diamonds, coins, currency, scrip, tokens, coupons, etc.

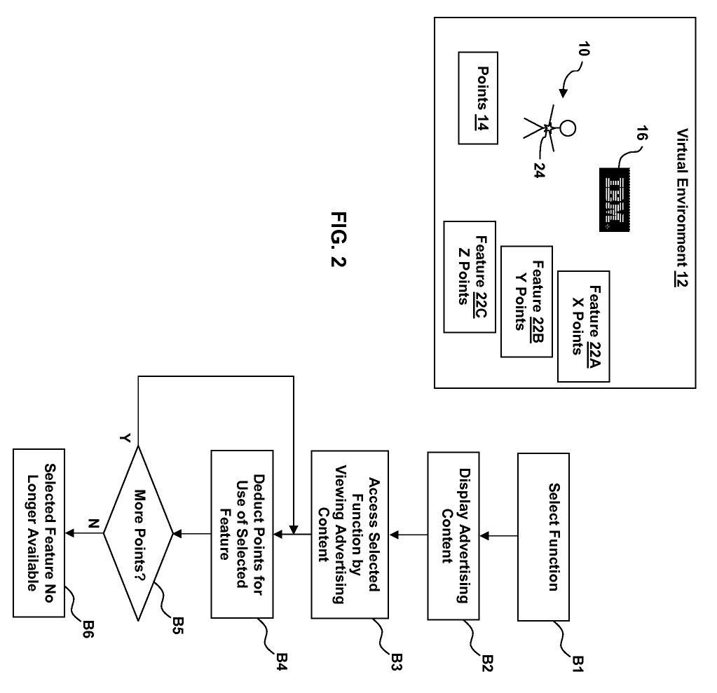

Point values are assigned to various features and functions 22 (aspects) available in the virtual environment 12 as depicted in FIG. 2. As an example, walking in the virtual environment 12 may not require any points 14, where flying may require the avatar 10 to have and spend some number of points 14.

Features and functions 22 (e.g., 22A-C) in the virtual environment 12, and/or enhancements thereto, can be made available to the avatar 10 based upon the number of points 14 compiled from viewing advertising content 16. Further, points 14 compiled from viewing advertising content 16 can be continuously deducted (e.g., spent) while a feature or function 22 is in use by the avatar 10. As an example, it may cost the avatar one point 14 for each 5 seconds of flying time.

In another embodiment, instant access to a feature 22 and/or instant enhancements thereto can be gained by viewing advertising content 16. As an example, advertising content 16 can be displayed (B2) to the avatar 10 in response to a selection (B1) of a given function 22 (e.g., the “fly” function). The avatar 10 can then gain access (B3) to the given function 22 by viewing the advertising content 16. Points 14 can be deducted (B4) as the function 22 is used by the avatar 10. When the points 14 are used up (B5), the function 22 is no longer available to the avatar 10.

In an embodiment, points 14 can be earned by the avatar 10 only within the virtual environment 12. In another embodiment, points can be earned within the virtual environment and/or by viewing advertising content 16 external to the virtual environment 12.

The points 14 earned while viewing advertisement content 16 in the virtual environment 12 can vary based on the vendor of the advertisement content 16, or can be the same for each vendor. For example, the advertisement content 16 sponsored by a first vendor can be worth more points 14 when viewed by the avatar 10 than the advertisement content 16 sponsored by a second vendor. This type of variation of points 14 can be used to promote the viewing of advertising content 16 of one vendor over other vendors. To this extent, a vendor can negotiate an agreement with the provider of the virtual environment 12 to assign points 14 to that vendor's advertisement content 16; more points 14—higher advertising rate, fewer points 14—lower advertising rates. Other schemes for assigning points 14 to advertising content 16 within the virtual environment 12 are also possible, based on the business model of the virtual environment 12 and factors.

In an embodiment, points 14 earned by the avatar 10 for viewing advertising content 16 can be used for any feature or function 22 within the virtual environment 12, while in another embodiment only specific features and functions 22 are based on points 14 earned for the viewing of advertising content 16. In yet another embodiment, there can be different types of points 14, and specific points 14 can be earned for specific features and functions 22. As an example, in order to “rent” a virtual meeting room, a certain number of meeting room points 14 would have to be acquired.

In an embodiment, features and functions 22 earned for viewing advertising content 16 can be made available globally to the avatar 10 in a given virtual environment 12, while in another embodiment the features and functions 22 can be made available only in a sponsored region or area.

As detailed above, the points 14 earned for viewing advertising content 16 can be stored as part of the avatar's 10 inventory in the virtual environment 12. These points 14 can be viewed, traded, auctioned and managed like other inventory items (A6, FIG. 1). The number of points 14 can be visually indicated on the body of the avatar 10. For example, as shown in FIG. 2, a star 24 or other indicia can be used to indicate the number of points 14 earned by the avatar 10. This visualization may be useful to potential marketers, sellers, and advertisers when interacting with avatars. Additionally, a summary number of points 14 can be indicated, associated with a landmark in the virtual environment 12, and indicative of the avatars 10 presently in a predetermined radius of the landmark. For example, the landmark may acquire a certain glow if the total number (or average number or other mathematical measure) of the points 14 of all avatars 10 nearby exceeds 1000.

The present invention provides vendor neutral enticement for avatars to view advertisement content (e.g., the more advertisement content viewed, the more points the avatar earns and the more features and functions available to the Avatar). In addition, the present invention provides incentives for an avatar to spend additional time in a virtual environment in order to earn more points (e.g., extended coverage of advertisement content). Further, the present invention provides a vendor specific reward system (e.g., advertisement content from one vendor is worth more points that advertisement content from other vendors).

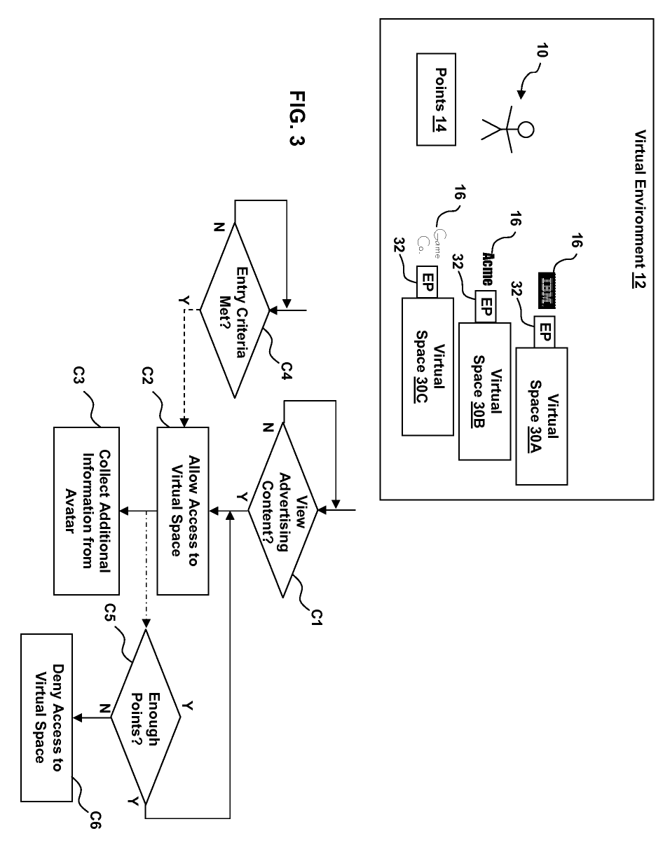

As depicted in FIG. 3, in an alternate embodiment, the present invention provides an avatar 10 the ability to gain access (C2) to a specific virtual space 30 (e.g., virtual spaces 30A-C) within a virtual environment 12 based on the viewing (C1) of advertisement content 16 and/or other vendor materials. This may include access to such things as virtual planets, virtual worlds, virtual continents, virtual islands, virtual stores, virtual rooms, and so forth.

The present invention provides a powerful advertising incentive. Avatars 10 of a virtual environment 12 can seek vendor sponsorship for virtual spaces 30, or vendors may create self-owned virtual spaces 30. The present invention also provides incentive for creativity of content in such virtual spaces 30. For example, the more interest in a virtual space 30, the more avatars 10 will view the advertising content 16 needed to gain access to that virtual space 30. Since there is endless “virtual real estate” in many virtual environments 12, and opportunity for creative content, the present invention provides a tremendous advertising source. In addition, with the competition for avatar 10 attention, better, more enjoyable and entertaining advertising content 16 results, making this a mutually beneficial arrangement between the avatar 10 and advertising vendors.

An example of a virtual space 30 in a virtual environment 12 is a restricted area, such as a private island or a casino. Once the avatar 10 clicks on corresponding advertising content 16, the avatar 10 may access the restricted area. This provides incentive to avatars 10 to view the advertising content 16.

Additional information can be collected (e.g., by a vendor) after the avatar 10 views the advertising content 16 (C3, FIG. 3). This can be done after, or in addition to, viewing of the advertising content 16. As an example, the avatar 10 may be asked to provide additional data, take a quiz, play a data collecting game, etc., thus providing the vendor with additional valuable data.

As depicted in FIG. 3, advertising content 16 (e.g., in the form of an icon), located adjacent the entry point 32 of a virtual space 30, can be viewed by the avatar 10 for immediate entry into the adjoining virtual space 30. An entry point 32 can be a door, a vehicle, a gate, a teleport, and the like. In another embodiment, points 14 are accumulated by the avatar 10 as advertising content 16 is viewed throughout the virtual environment 12 and, based on entry criteria (e.g., the number of available and required points), the avatar 10 may or may not be granted entry (C4) to a given virtual space 30.

In an embodiment, the avatar 10 can have general open access to one or more virtual spaces 30 based on accumulated points 14. As an example, a virtual space 30 may require ten points 14 to enter, and as long as the avatar 10 has ten points 14 available (C5), access is granted, otherwise access is denied (C6). If the avatar 10 is already in the virtual space 30 when access is denied, the avatar 10 must exit the virtual space 30. In another embodiment, points 14 can be associated with a vendor, and a number of vendor specific points 14 can be required (C4) to access vendor sponsored virtual spaces 30. As an example, the avatar 10 can be required to have ten “IBM points” in order to access the virtual space 30A “IBM Island.”

In an embodiment, accumulation of points 14 can provide vendor neutral or vendor specific modifications to a virtual space 30. As an example, while on IBM Island, an avatar 10 with fifty IBM points 14 may see a door or other passage sponsored by IBM that can not be seen by other avatars 10 in the same virtual space 30. In another embodiment, the visible content of a virtual space 30 can be altered based on general or vendor specific points 14. As an example, when entering a virtual museum, an avatar with one-hundred points 14 may see twice as many exhibits as an avatar with fifty points in the same museum.

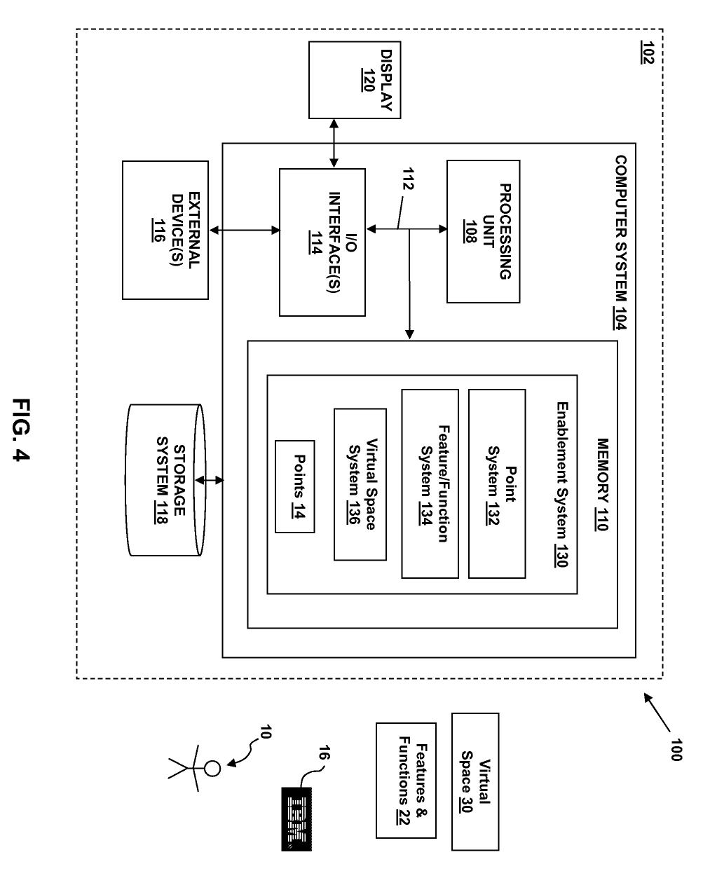

FIG. 4 depicts an illustrative system 100 for carrying out and/or implementing an enablement system 130 for enabling virtual environment functions and features through advertisement exposure in accordance with any/all embodiments of the present invention. The system 100 includes a computer infrastructure 102 that can perform the various processes described herein. The computer infrastructure 102 is shown including a computer system 104.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code, such as the enablement system 130, that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device(s) 116 can comprise any device (e.g., display 120) that enables a user to interact with the computer system 104 or any device that enables the computer system 104 to communicate with one or more other computer systems.

The enablement system 130 includes various systems for implementing any/all embodiments of the of the present invention. For example, the enablement system 130 can include a point system 132 for compiling the number of points 14 accumulated by an avatar 10 for viewing advertising content 16 and for deducting points 14 based on features and functions 22 and virtual spaces 30 accessed by the avatar 10, a feature/function system 134 controlling the availability of various features and functions 22 to the avatar 10 based on the number of points 14, and a virtual space system 136 for providing selective access to one or more virtual spaces 30. The operations carried out by each of these systems is described in greater detail above.

The computer system 104 can comprise any general purpose computing article of manufacture capable of executing computer program code installed by a user (e.g., a personal computer, server, handheld device, etc.). However, it is understood that the computer system 104 is only representative of various possible computer systems that may perform the various processes of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in an embodiment, the computer infrastructure 102 comprises two or more computer systems (e.g., a server cluster) that communicate over any type of wired and/or wireless communications link, such as a network, a shared memory, or the like, to perform the various processes of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

It is understood that some of the various systems shown in FIG. 4 can be implemented independently, combined, and/or stored in memory for one or more separate computer systems that communicate over a network. Further, it is understood that some of the systems and/or functionality may not be implemented, or additional systems and/or functionality may be included as part of the system 100.

It is understood that the invention further provides various alternative embodiments. For example, in an embodiment, the invention provides a computer-readable medium that includes computer program code to enable a computer infrastructure to carry out and/or implement the various processes of the present invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the processes of the invention on a subscription, advertising, and/or fee basis. A service provider can create, maintain, support, etc., a computer infrastructure, such as the computer infrastructure 102, that performs the processes of the invention for one or more customers. In return, the service provider can receive payment from the customer(s) under a subscription and/or fee agreement and/or the service provider can receive payment from the sale of advertising space to one or more third parties.

In still another embodiment, a computer infrastructure, such as the computer infrastructure 102, can be obtained (e.g., created, maintained, having made available to, etc.) and one or more systems for performing the processes of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the processes of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. The program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for enabling aspects of a virtual environment to an avatar, comprising:
viewing advertising content within the virtual environment; and
earning a number of points for viewing the advertising content.

2. The method of claim 1, wherein the viewing of advertising content is selected from the group consisting of actively viewing the advertising content and passively viewing the advertising content.

3. The method of claim 2, further comprising:
earning a first number of points for actively viewing the advertising content; and
earning a second number of points for passively viewing the advertising content.

4. The method of claim 3, wherein the first number of points and the second number of points can comprise a same number of points or a different number of points.

5. The method of claim 1, wherein an aspect comprises a feature or function of the virtual environment.

6. The method of claim 1, further comprising:
assigning a point value to an aspect of the virtual environment; and
enabling the avatar to access or enhance the aspect in the case the avatar has earned a sufficient number of points.

7. The method of claim 6, further comprising:
deducting the point value assigned to the aspect from the number of points earned by the avatar in the case the avatar accesses or enhances the aspect.

8. The method of claim 1, further comprising:
allowing the avatar to immediately access an aspect of the virtual environment upon viewing the advertising content.

9. The method of claim 1, further comprising:
visually indicating on the avatar the number of points earned by the avatar.

10. The method of claim 1, further comprising:
assigning a point value to a virtual space of the virtual environment; and
enabling the avatar to access the virtual space in the case the avatar has earned a sufficient number of points.

11. The method of claim 10, further comprising:
deducting the point value assigned to the virtual space from the number of points earned by the avatar in the case the avatar accesses the virtual space.

12. The method of claim 10, further comprising:
adjusting a visual content of the virtual space based on the number of points earned by the avatar.

13. The method of claim 1, wherein the number of points earned by the avatar for viewing the advertising content is based on a vendor of the advertising content.

14. A system for enabling aspects of a virtual environment to an avatar, comprising:
a system for viewing advertising content within the virtual environment; and
a system for earning a number of points for viewing the advertising content.

15. The system of claim 14, wherein the system for viewing comprises at least one of:
a system for actively viewing the advertising content; and
a system for passively viewing the advertising content.

16. The system of claim 15, wherein a first number of points is earned for actively viewing the advertising content, and a second number of points is earned for passively viewing the advertising content.

17. The system of claim 16, wherein the first number of points and the second number of points can comprise a same number of points or a different number of points.

18. The system of claim 14, wherein an aspect comprises a feature or function of the virtual environment.

19. The system of claim 14, further comprising:
a system for assigning a point value to an aspect of the virtual environment; and
a system for enabling the avatar to access or enhance the aspect in the case the avatar has earned a sufficient number of points.

20. The system of claim 19, further comprising:
a system for deducting the point value assigned to the aspect from the number of points earned by the avatar in the case the avatar accesses or enhances the aspect.

21. The system of claim 14, further comprising:
a system for allowing the avatar to immediately access an aspect of the virtual environment upon viewing the advertising content.

22. The system of claim 14, further comprising:
a system for visually indicating on the avatar the number of points earned by the avatar.

23. The system of claim 14, further comprising:
a system for assigning a point value to a virtual space of the virtual environment; and
a system for enabling the avatar to access the virtual space in the case the avatar has earned a sufficient number of points.

24. The system of claim 23, further comprising:
a system for deducting the point value assigned to the virtual space from the number of points earned by the avatar in the case the avatar accesses the virtual space.

25. The system of claim 23, further comprising:
a system for adjusting a visual content of the virtual space based on the number of points earned by the avatar.

26. The system of claim 14, wherein the number of points earned by the avatar for viewing the advertising content is based on a vendor of the advertising content.

27. A program product stored on a computer readable medium, which when executed, enables aspects of a virtual environment to an avatar, the computer readable medium comprising program code for:
viewing advertising content within the virtual environment; and
earning a number of points for viewing the advertising content.

28. A method for deploying an application for enabling aspects of a virtual environment to an avatar, comprising:
providing a computer infrastructure being operable to:
view advertising content within the virtual environment; and
earn a number of points for viewing the advertising content.
